(19) United States
(12) Patent Application Publication
(10) Pub. No.: US 2012/0123022 A1
(43) Pub. Date: May 17, 2012

(54) METHOD AND APPARATUS FOR CONTINUOUSLY MIXING FIBERS WITH A BINDING AGENT

(76) Inventors: Jochem Berns, Grefrath (DE); Wilhelm Franck, Toenisvorst (DE); Karsten Lempfer, Toenisvorst (DE)

(21) Appl. No.: 13/319,415

(22) PCT Filed: May 11, 2010
(86) PCT No.: PCT/EP2010/056411

§ 371 Date: Jan. 20, 2012

(30) Foreign Application Priority Data
May 15, 2009 (DE) 102009021615.4
Dec. 11, 2009 (DE) 102009057916.8

(51) Int. Cl. B01F 3/18; B29B 7/94; B29B 7/80

(52) U.S. Cl. 523/322; 366/99; 366/76.6

(57) ABSTRACT

The invention relates to a method for continuously mixing fibers with a binding agent for producing fiberboards in a continuously operating mixing apparatus which comprises at least one mixing chamber and one or a plurality of mixing tools fastened to a rotating mixer shaft, wherein the mixing tools mix the fibers with the binding agent and convey it in a conveying direction through the mixer. Said method is characterized in that the rotational speed (n) of the mixer shaft and the diameter (d) of the mixing chamber are matched to each other with the proviso that the (nominal) centrifugal acceleration of the fibers in the region of the mixer inside wall is 10000 to 30000 m/sec².

The invention relates to a method of continuously mixing fibers with a binder to produce fiberboard in a continuously operating mixing apparatus that has at least one mixing chamber and one or more mixing tools attached to a rotating mixer shaft, where the mixing tools mix the fibers with the binder and transport them in a transport direction through the mixer or the mixing chamber. In addition, the invention relates to a mixing apparatus for mixing fibers with a binder. Mixing apparatuses of this type are also referred to as gluing mixers. The mixing chamber is typically a cylindrical drum, although this drum does not rotate but is stationary.

Coating fibers with glue and thus mixing fibers with a binder or glue is an essential process step in producing fiberboard. The quality of the fiberboard, for example wood-based boards, significantly depends on the quality of the fibers and in particular on a homogeneous coating of the fibers with glue.

The approach is known in principle whereby wood fibers are mixed in what is called a blowline with a binder or glue, and thus coated with glue. The throughput capacity for this glue-coating technology is limited, however. Problems have furthermore sometimes arisen in practice in terms of so-called glue spots. The handling of isocyanate binder in particular has caused problems in blowline technology.

For this reason, the approach has already been proposed for coating the fibers with glue in a mixer. The results that have been achieved in practice in the past using known glue-coating mixers have however often been unsatisfactory.

An apparatus for continuously coating fibers with glue, where the apparatus is constructed as a horizontally extending glue-coating mixer using a drum-type design, has been disclosed, for example, in DE 24 38 818 [U.S. Pat. No. 4,006,887]. The mixer shaft in this embodiment is hollow and functions to supply the glue. To this end, the mixer shaft is fitted with mixing tools, the region of their hollow area being equipped with glue-centrifuging tubes that project therefrom. The diameter of this type of mixing container is approximately 600 mm, and a rotational speed of 1500 revolutions per minute is proposed for the mixer shaft. The intended goal here is to achieve a throughput performance of 3 to 4 t of fiber per hour.

In previous practical experience, care had to be taken when coating fibers with glue using apparatuses of this type that the fibers to be coated with glue, which are set into a “rotating” motion by the mixing tools, have a specified rotation rate or peripheral speed. Mixers of different diameters are therefore operated in practice at substantially different rotational rates so as to set comparable speeds. The results achieved in this way have frequently been unsatisfactory.

The object of this invention is to provide a method of continuously mixing fibers with a binder to produce fiberboard of the type described above, which method ensures perfect glue-coating results with simultaneously high throughput.

In order to achieve this object, the invention teaches an approach relating to a method of the generic kind for continuously mixing fibers with a binder to produce fiberboard of the type described above, wherein the rotational speed n of the mixer shaft and the diameter d of the mixing chamber are matched to each other to meet the requirement that the (nominal) centrifugal acceleration of the fibers adjacent the inner wall of the mixer is 10,000 to 30,000 m/sec². The (nominal) centrifugal acceleration is preferably 15,000 to 30,000 m/sec². The fibers are accelerated by the rotating mixer shaft by the mixing tools outward toward the mixer housing, and then move essentially as a fiber ring through the mixer. The (nominal) centrifugal acceleration does not (necessarily) relate to the actual centrifugal acceleration of the moved fibers; what is referenced instead is a value for the is centrifugal acceleration a that is computed from the rotational speed n and diameter d as follows:

a=2 π² n²·d.

Diameter refers to the inside diameter of the mixing chamber. The invention is based on the discovery that optimal glue-coating depends less on the speed or circumferential speed of the fibers, but rather on the centrifugal acceleration of the fibers. High accelerations rates are established within the scope of the invention so that, for example operation can preferably be effected with relatively small diameters of the mixing chamber and relatively high rotational speeds of the mixer shaft. The invention preferably proposes an approach whereby the diameter d of the mixing chamber is 200 mm to 800 mm, preferably 300 mm to 700 mm. The rotational speed n of the mixer shaft can preferably be 1000 to 4000 rpm, especially preferably, 2000 to 4000 rpm.

The method according to the invention is first of all suitable for coating wood fibers with glue, for example for MDF production. Fibers from annual plants, for example fibers from straw, for example rice straw, are also especially preferably coated with glue within the scope of the invention. The binder used in particular for these types of fibers from annual plants is isocyanate or contains isocyanate. This binder is particularly io well suited for these types of annual plants since some annual plants are often provided with a wax coating. The strong adhesive action of isocyanate-containing binders ensures problem-free processing despite this. A flawless glue-coating result is achieved using the method according to the invention with its high is centrifugal acceleration rates—without those problems occurring that have been observed previously in practice

The method according to the invention is surprisingly especially well-suited for mixing fibers, and wood fibers in particular, with thermoplastic synthetic fibers, for example bicomponent fibers. An approach is known in principle whereby not only thermosetting binders such as, for example isocyanates, are used as the binders for wood-based boards, but instead it has already been proposed to use thermoplastic synthetic fibers, for example bicomponent synthetic fibers as binders, which fibers are mixed with the wood fibers and, for example dispersed using a mechanical dispersion head into a mat. Multi-component fibers of this type are distinguished by the fact that they have at least one first and one second synthetic component, where the synthetic components have different melting points. When the fiber mat is heated, one component, for example the second component of the synthetic fibers softens, after which the fiber mat is used to produce fiberboard, for example insulation board. Bicomponent filaments of this type surprisingly can be mixed homogeneously and with a high throughput especially effectively with wood fibers.

The subject matter of the invention is also an apparatus for continuously mixing fibers with a binder to produce fiberboard, in particular, as set forth in a method of the type described above. The basic construction of this apparatus essentially has a horizontally extending cylindrical mixing chamber and at least one mixer shaft that is rotatable in the mixing chamber, a plurality of mixing tools being attached to the mixer shaft. The mixing chamber has at least one fill opening to supply the fibers and at least one outlet opening to discharge the fiber-binder mixture and a plurality of binder openings to supply the binder. The invention proposes an approach wherein a plurality of stiff combs are distributed as mixing tools around the outer surface of the mixer shaft, each of the stiff combs being provided with radially outwardly directed teeth, the stiff combs extending essentially parallel to the mixer axis, and every two adjacent stiff combs are offset by a predetermined amount relative to each other. These stiff combs or teeth perform both a mixing function and also a transport function, since the fibers are not only mixed with the binder during rotation of the mixer shaft by the mixing tools, but the mixture is also simultaneously transported without problem and with a high throughput in the transport direction from the fill opening to the outlet opening. The axial offset of the individual stiff combs enables an essentially spiral-shaped configuration of the teeth to be achieved, which configuration improves the transport effect. The individual teeth can also be referred to as rods or pins. These teeth or rods or pins are preferably designed without binder supply, i.e. the binder is not supplied through the teeth themselves but through separate (nonrotating) binder supply tubes that project, for example radially or tangentially by a predetermined amount through the mixing chamber housing into the interior of the mixing chamber. It is advantageous in this regard for the supply tubes projecting inside the mixing chamber are offset longitudinally relative to the teeth or to the stiff combs. This design allows the stiff combs to easily rotate at high speeds without colliding with the supply tubes, despite the fact that the supply tubes can project into the region of the teeth.

Alternatively, a possible approach is for the stiff combs to have a plurality of short teeth in the region where the supply tubes are provided. These short teeth adjacent the supply tubes consequently are of shorter length than the remaining teeth that are outside the region of the supply tubes. It is not necessary with this design for the supply tubes to be longitudinally offset relative to the teeth. The length of these short teeth is matched here to the amount by which the supply tubes project into the interior of the chamber.

Thee binder supply tubes are especially preferably disposed in the first half of the mixing chamber (relative to the transport direction), especially preferably in the first third of the mixing chamber. For example, two to ten, preferably three to seven glue supply tubes can be provided here that are arranged in pairs in the longitudinal direction of the mixer. It is also possible in principle to provide a plurality of such rows of supply tubes that can be distributed around the outer surface, or also distributed across the length of the chamber.

In an alternative design, the invention also comprises forms of implementation in which the binder is supplied through the io mixer shaft and the mixing tools, for example the teeth. The mixer shaft in this type of mixer with “internal gluing” is provided in the form of a hollow shaft, and the teeth are proved simultaneously in the form of binder supply tubes that are connected to the mixer shaft.

In another proposal of the invention, provision is made whereby the region of the mixer shaft near the fill opening is free of teeth, and transport tools, for example transport paddles are provided in this supply region. The fibers entering the mixing chamber through the fill opening are consequently transported quickly and reliably away by the transport tools, which act essentially as pushers, into the mixing region where they are then transported on by the teeth.

In another proposal, the region near the outlet opening can optionally or additionally be free of teeth, and ejection tools, for example, ejection paddles, are provided in this discharge region.

The fill opening is preferably disposed on top of the mixing chamber, and is provided, for example in the form of a loading funnel. The outlet opening or ejection opening is preferably provided on the bottom, for example in the bottom half of the mixing chamber, with the result that in overall terms loading and unloading are effected essentially by gravity.

If the operation is effected using glue supply tubes that project essentially radially or tangentially through the mixer housing into the interior of the mixer, it is possible within the scope of the invention to provide these glue tubes so as to be height-adjustable. This means that the insertion depth of the glue tubes radially or tangentially into the interior of the mixing chamber can be adjusted. It is possible to use glue-coating tubes with single-component or two-component atomization.

In addition, at least one drive is connected to the mixer shaft, optionally by interposing a gear transmission. The ejection side of the drive is preferably connected to the mixer shaft. This design is especially advantageous when interior glue-coating is employed and the glue is introduced through the supply side into the mixer shaft.

The invention furthermore proposes an approach whereby the teeth or pins are wear-resistant. The inside walls of the mixing chamber or the mixer housing can also be wear-resistant, for example with hard facing. This wear-resistant embodiment is especially advantageous since mixing silicate-containing fibers, for example straw, can involve silicates emerging that strongly wear on the surface. The housing of the mixer can, for example be cooled, preferably by water cooling.

The following describes the invention in more detail based on a drawing that illustrates only one embodiment. Therein:

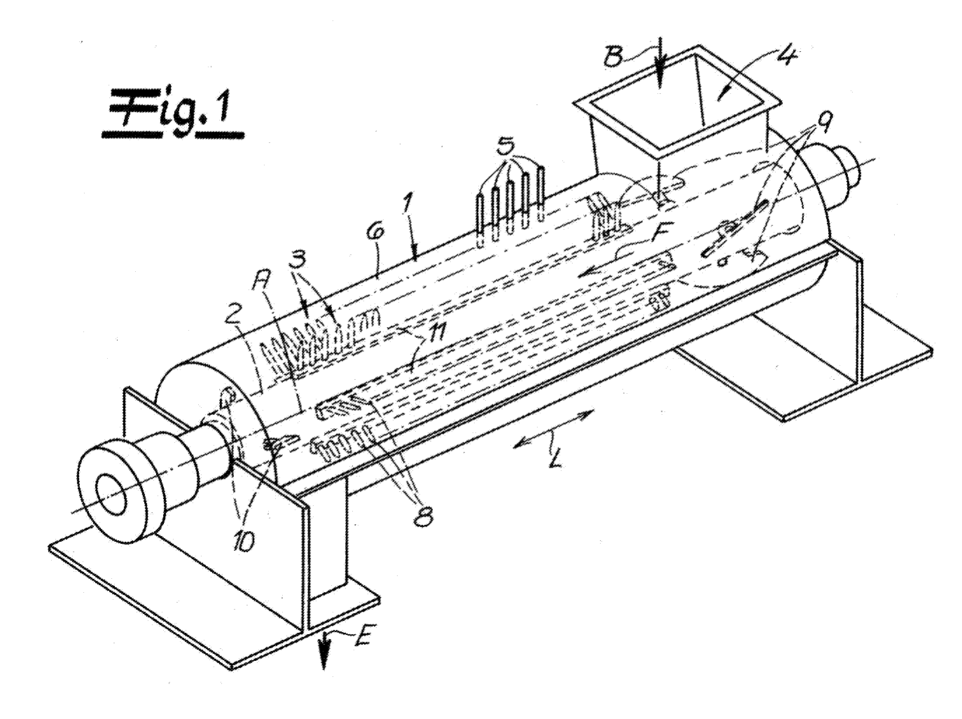

FIG. 1 is a simplified perspective view of a mixing apparatus according to the invention;

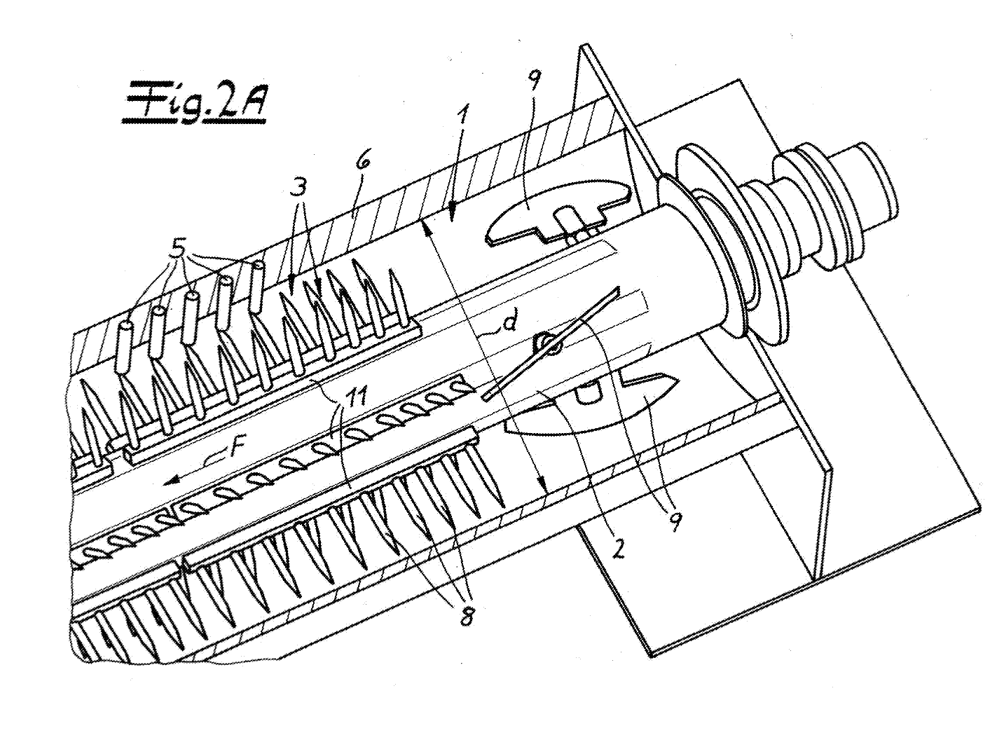

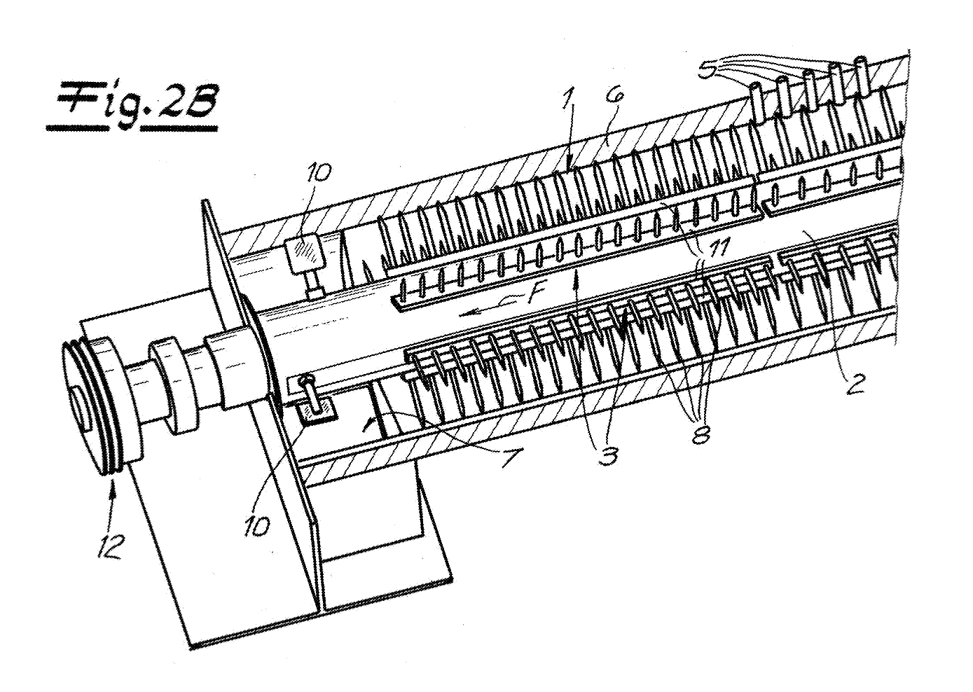

FIG. 2a shows an enlarged section of the structure in FIG. 1 adjacent fiber supply;

FIG. 2b shows another enlarged section of the structure of FIG. 1 adjacent discharge for the fiber-binding-agent mixture;

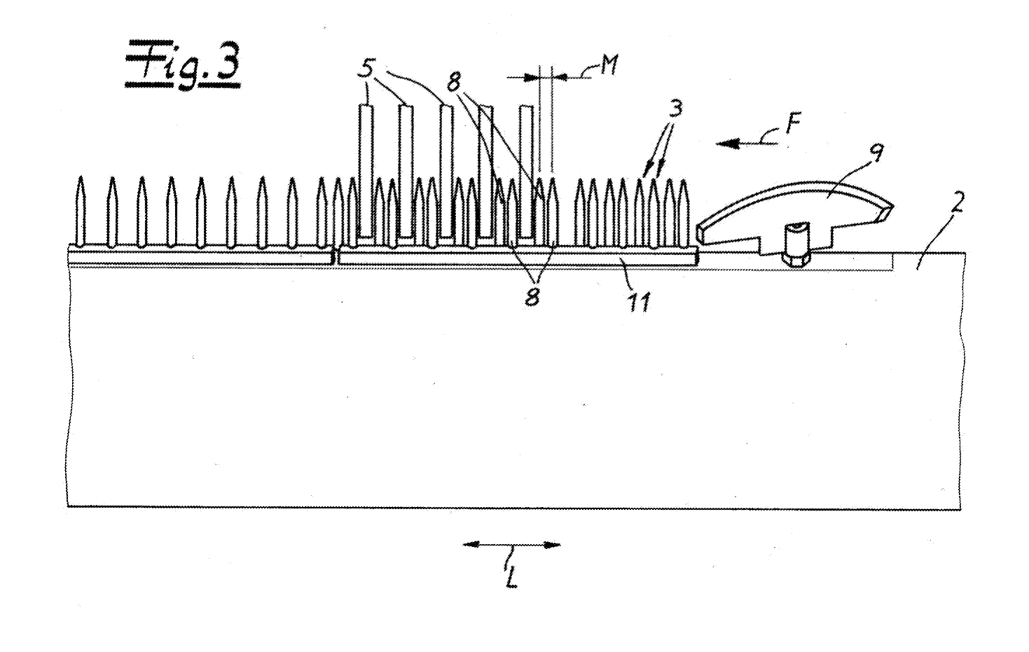

FIG. 3 provides another section of the structure of FIG. 1; and

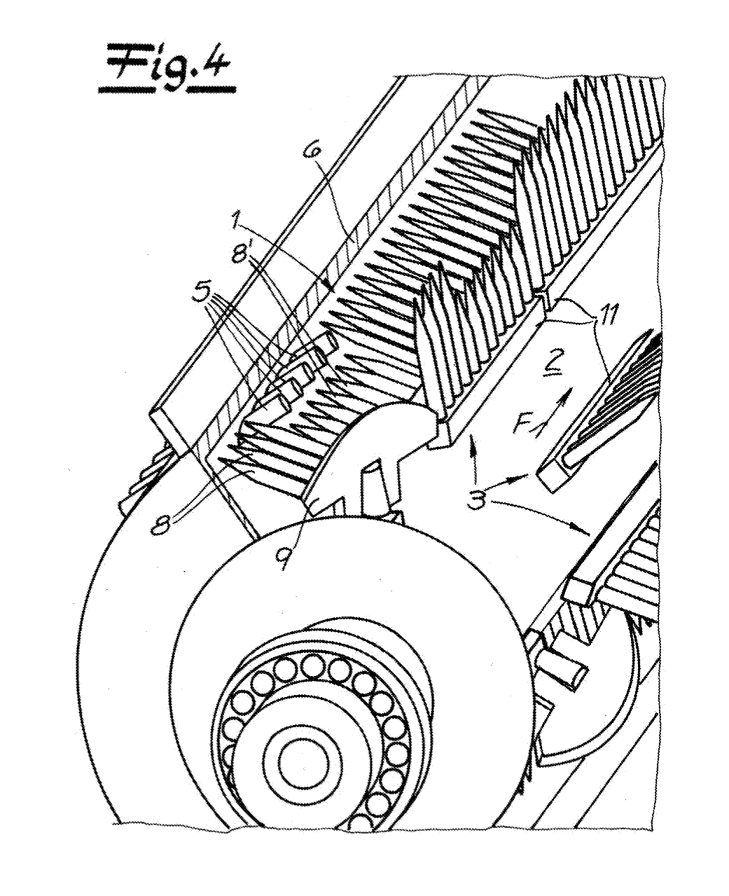

FIG. 4 shows a section of a modified embodiment of a mixing apparatus and from a different perspective.

The figures show a mixing apparatus for continuously mixing fibers with a binder to produce fiberboard. The mixing apparatus comprises an essentially horizontal chamber 1 with a cylindrically tubular housing 6 and at least one mixer shaft 2 rotatable in the mixing chamber 1 and carrying a plurality of mixing tools 3. The mixing chamber has a fill opening 4 that here is a loading funnel. The fibers are introduced into the interior of the mixing chamber 1 through this loading funnel from above This is indicated by arrow B. The tools 3 attached to the rotating mixer shaft 2 mix fibers with a binder and simultaneously transport the mixture in the direction F through the mixer. The binder is supplied through a plurality of binder tubes 5 that are attached to the chamber 1 and project completely through its housing 6 into the interior of the chamber 1. In the illustrated embodiment, the supply of binder is consequently effected not by the mixer shaft or by the mixing tools but by the supply tubes 5 that are in the form of supply nozzles permanently attached to the chamber 1 or to the housing 6 of the chamber 1. In addition, the mixing apparatus has an outlet opening 7 at the downstream end in the transport direction F. The mixture consisting of fibers and binder is discharged or ejected through this outlet opening 7. This is indicated by arrow E. The outlet opening 7 is provided here in the bottom of the chamber 1.

Here, a plurality of stiff combs distributed over the outer surface of the mixer shaft 2 are provided as mixing tools 3, the combs each having a plurality of radially outwardly directed teeth 8 and 8′. The stiff combs extend along the longitudinal direction of the mixing chamber and thus parallel to the longitudinal axis A of the mixer. For example, three to fifteen, preferably five to ten stiff combs 3 can be distributed over the outer surface of the mixer shaft 2. The invention proposes an approach whereby two stiff combs 3 each are offset in the axial or longitudinal direction L by a predetermined amount M relative to each other. This design results in the ends of individual teeth 8 or 8′ ly8ng essentially on a spiral as seen in a top view. This ensures that not only is a problem-free mixing of the fibers effected with the binder, but also that a problem-free transport of the mixture is ensured with high throughput. The supply tubes 5 in the embodiments are disposed in rows extending along the longitudinal direction L of the mixer.

In the embodiment of FIGS. 1 through 3, the supply tubes 5 that project completely through the mixer wall 6 into the mixing chamber are offset relative to the teeth 8 of the stiff combs 3. This is shown, for example, FIG. 3. It is evident that the supply tubes 5 essentially between the teeth 8 of the stiff combs 3 in this embodiment without any collisions occurring between the teeth 8 and the supply tubes 5. The design is chosen so that the clearance between the teeth 8 and the supply tubes 5 is at least 2 mm, preferably at least 4 mm.

In the modified embodiment of FIG. 4, the supply tubes 5 are not offset relative to teeth 8 and 8′ but aligned essentially flush. Here shortened teeth 8 are provided adjacent the supply tubes 5 so as to avoid any collisions between teeth 8 and 8′ and the supply tubes 5. The length of teeth 8′ adjacent the supply tubes 5 is consequently shorter than the length of teeth 8 in the other regions of the mixer.

The figures furthermore illustrate that the region of the mixer shaft 2 near the fill opening 4 is designed to be tooth-free, transport tools 9 being attached to the mixer shaft 2 in this supply region. These transport tools in the embodiment are provided in paddle form as pushing tools or pushing paddles. They ensure that the fibers entering into the chamber 1 through the fill opening 4 are quickly accelerated and are transported into the glue-coating region (see FIG. 2a).

It is furthermore evident that the region of the mixer shaft 2 near the outlet opening 7 is also tooth-free, ejection tools 10 being attached to the mixer shaft 2 in this outlet region. These ejection tools 10 are also provided in paddle-shape as ejection paddles. They ensure rapid discharge of the mixture of fibers and binder, and thus of the glue-coated fibers through drop opening 7 (see FIG. 2b).

The mixer tools 3 provided as stiff combs include a mounting bar 11 that extends along a longitudinal direction L and thus parallel to an axis A. The teeth or pins 8 and 8′ are attached to this mounting bar 11. The teeth 8 and 8′ here extend orthogonally to the mounting bar 11.

An unillustrated drive, not shown, is connected in the manner known per se to the mixer shaft 2. Only a belt pulley 12 is indicated in FIG. 2b for connecting the drive to the mixer shaft 2. The drive is thus disposed downstream end or outlet in the illustrated embodiment.

When the mixing apparatus according to the invention is operating, fibers are introduced through the funnel 4 into the chamber 1 as indicated by arrow B, while binder, for example glue, such as for example isocyanate is simultaneously supplied through the supply tubes 5. The fibers are transported by the mixing tools 3 according to the invention in the longitudinal direction L and in the process moved by centrifugal acceleration outwardly, and thus into the region of mixer wall 6. A rotational speed n of the mixer shaft and diameter d of the mixing chamber are matched to each other according to the invention so that (nominal) centrifugal acceleration a of the fibers is from 15,000 to 30,000 m/sec² adjacent the mixer wall. The diameter d is preferably 300 mm to 700 mm, while the rotational speed n of the mixer shaft is preferably 2000 to 4000 rpm. Operation is thus effected with relatively small diameters and high rotational speeds, thereby achieving high centrifugal accelerations. This ensures that the fibers are pressed effectively against the housing 6 or the inner surface of the mixer 1 and essentially compressed. This results in increased friction and thus in an improved glue-coating performance. At the same time, high throughput levels of, for example 5 t to 10 t per hour can be achieved.

1. A method of continuously mixing fibers with a binder to produce fiberboard in a continuously operating mixing apparatus that has at least one housing defining mixing chamber and one or more mixing tools attached to a rotating mixer shaft inside the housing the method comprising the steps of:
feeding the fibers and the binder into a supply end of the mixing chamber;
rotating the shaft such that the mixing tools orbit and mix the fibers with the binder and transport the mixed binder and fibers in a transport direction through the mixing chamber longitudinally away from the supply end, and
setting a rotational speed of the mixer shaft a relative to a diameter of the mixing chamber such that a centrifugal acceleration of the fibers adjacent the mixing chamber housing is 10,000 to 30,000 m/sec².

2. The method according to claim 1, centrifugal acceleration of the fibers is 15,000 to 30,000 m/sec² adjacent the mixing chamber housing.

3. The method according to claims 1, wherein the centrifugal acceleration (a) of the fibers is computed from the rotational speed (n) and the diameter (d) as follows: a=2 π² n²·d.

4. The method according to claim 1, wherein the diameter of the mixing chamber is 200 mm to 800 mm.

5. The method according to claim 1, wherein the rotational speed of the mixer shaft is approximately 1000 to 4000 rpm.

6. The method according to claim 1, wherein a thermosetting binder is used to glue the fibers.

7. The method according to claim 1 wherein fibers composed of wood or of annual plants are mixed with the binder.

8. The method according to claim 1, wherein fibers are mixed with a thermoplastic binder.

9. The method according to claim 8, wherein the thermoplastic fibers used are multicomponent fibers that are composed of at least one first and one second synthetic component that have different melting points.

10. An apparatus for continuously mixing fibers with a binder to produce fiberboard, comprising:
at least one mixing chamber with a longitudinally extending and cylindrical mixing chamber housing, the mixing chamber being essentially horizontal,
at least one mixer shaft rotatable in the mixing chamber and carrying a plurality of mixing tools the mixing chamber having at least one fill opening for the fibers and at least one outlet opening for the fiber-binder mixture and a plurality of binder supply openings to supply the binder, and
a plurality of stiff combs that are distributed around the outer surface of the mixer shaft, run parallel to a longitudinal axis of the mixer, that serve as mixing tools, and that comb each include a plurality of teeth, each two angularly adjacent stiff combs being offset by a predetermined amount in an axial or longitudinal direction of the mixer.

11. The apparatus according to claim 10, wherein the teeth are not provided with binder supply means, the apparatus further comprising:
supply tubes that supply the binder and that project into the interior of the mixing chamber.

12. The apparatus according to claim 10, wherein the teeth themselves are provided in the form of binder supply tubes that are connected to a mixer shaft that is hollow.

13. The apparatus according to claim 11, wherein the supply tubes project into the mixing chamber, are preferably oriented radially or tangentially, and are offset relative to the teeth or the stiff combs.

14. The apparatus according to claim 11, wherein the teeth of the stiff combs adjacent the supply tubes are shortened and are of a length that is reduced relative to the other teeth.

15. The apparatus according claim 10, wherein the region of the mixer shaft near the fill opening is tooth-free, transport tools being attached to the mixer shaft in this supply region of the mixer shaft.

16. The apparatus according to claim 10 wherein the region of the mixer shaft near the outlet opening is tooth-free, ejection tools, for example ejection paddles, being attached in this discharge region of the mixer shaft to the mixer shaft.

17. The apparatus according to claim 10, wherein the mixing tools formed stiff combs each include a mounting bar that is oriented parallel to the longitudinal direction of the mixer and is attached to the mixer shaft, a plurality of teeth oriented orthogonally relative to the mounting bar being attached to the mounting bar.
